(19) United States
(12) Patent Application Publication
(10) Pub. No.: US 2023/0041677 A1
(43) Pub. Date: Feb. 9, 2023

(54) Systems and Methods for Aerodynamic Delivery of an Animal Attractant

(71) Applicants: Noah Stigall, Kansas City, MO (US); Charles Prichard, Kansas City, MO (US)

(72) Inventors: Noah Stigall, Kansas City, MO (US); Charles Prichard, Kansas City, MO (US)

(21) Appl. No.: 17/397,918

(22) Filed: Aug. 9, 2021

(51) Int. Cl. A01M 31/00; F41B 3/02; F42B 12/46

(52) U.S. Cl. CPC A01M 31/008; F41B 3/02; F42B 12/46

(57) ABSTRACT

The invention provides an improved finger-held sling and associated systems, kits, and methods of use for delivering an attractive scent to an area that is remotely located from a user. Advantageously, the invention creates little or no undesirable noise and does not necessitate introducing human scents into the delivery area. Kits of the invention are compact, lightweight, ready to use, and do not require the user to apply an attractant prior to use.

### BACKGROUND OF THE INVENTION

### A. Field of the Invention

The present invention relates to improved systems and methods for dispensing an animal attractant. Specifically, the invention provides systems, kits, and methods for distributing a scent.

### B. Description of the Related Art

Game animals such as deer, elk, and bear are attracted to certain natural scents, such as the urine or musk of a male or female of its own species. Other animals can be attracted by another appropriate scent. Typically, the scent is in a liquid and either applied directly to a suitable surface, such as the ground or a tree, or poured onto a material such as an absorbent pad that is attached to or hung in the area to which animals are to be attracted. As the liquid evaporates, the scent is released into the ambient air.

There are several challenges to successfully attracting animals to a desired area using a scent attractant. Direct application of an attractant to an area can result in human scent and noise being introduced into the area. Both of which will deter animals for being attracted and defeat the intended purpose of applying the attractant.

A variety of devices and methods have been developed to dispense scent lures from a distance. For example, U.S. Pat. Nos. 5,456,036 and 5,303,496 and U.S, Pub. Pat. App. No. 2008/0313947 each describe the use of a gun for the remote delivery of a scent lure. These delivery methods will result in unwanted noise. U.S. Pat. Nos. 5,836,842, 6,027,036 and 6,174,251 use arrows as the delivery method. While quieter, each requires that a user apply scent to the arrows just prior to delivery. Applying scent in the field can be messy, wasteful, and result in the user undesirably smelling of the attractant either because of spillage or because the scent becomes aerosolized during application.

Other attempts to dispense scent lures within a given area without introducing undesirable human scents in the process include shooting sticky or exploding pellets into the area. These methods are complicated, expensive, non-reusable, create unnecessary and unwanted noise, require additional equipment, or require significant force to break open the pellet. Additionally, many of the attractants are not eco-friendly and are made of synthetic and non-biodegradable materials. An inexpensive, simple, and versatile scent lure dispenser that addresses these deficiencies in the art is desirable.

### SUMMARY OF THE INVENTION

The present invention provides improved systems, kits, and methods for dispensing an attractive scent to an area that is distant from the user. More specifically, the invention provides a finger-held, flexible sling that can quietly launch a projectile sufficiently far from the user to avoid contaminating the desired location with human scent or having to traverse to the desired area. Advantageously, the invention provides projectiles that are ready to use and eliminates the need for a user to apply a scent before use. Kits of the invention are lightweight and easy to transport. For example, a kit can fit into a user's pocket.

The invention provides an improved scent lure dispenser that can be easily, economically, and efficiently manufactured and is easy to use.

Systems of the invention for projecting a scent from one location to another location comprise a sling and a projectile. The sling comprises a first loop, a second loop, and a flexible or elastic band that has two ends. The first loop is attached to a first end of the elastic band, and the second loop is attached to a second end of the elastic band. Preferably, the first loop is attached to the first end of the elastic band with two fasteners, and the second loop is attached to the second end of the elastic band with two fasteners. The projectile is comprised of wood and saturated with an animal attractant such as deer urine.

Slings that form a part of the invention are comprised of rectangular bands of flexible material. Suitable materials for the slings are rubber or elastic-based. Those of skill in the art will appreciate that there a number of flexible materials that are suitable for use in the invention.

Similarly, the first and second loops are flexible. Preferably, the first and second loops are slender as compared to the sling and comprised of leather. Leather is a preferred material for the loops as it is comfortable and maintains its shape over wide ranges of temperature and humidity that a user may encounter. While leather is preferred, the loops may be made of a variety of materials that are flexible, durable, and comfortable to the user.

Those of skill in the art will appreciate that a wide variety of fasteners are suitable for inclusion in the invention. For example, suitable fasteners include screws, stitching, or staples. Most preferably, the fasteners are rivets.

Systems and kits of the invention include a projectile that is a sphere or ovoid in shape and includes a centrally located hole of variable depth. As the purpose of the hole is to increase the surface area through which an attractant can be absorbed, the hole can be of variable width and depth but cannot penetrate completely through the projectile.

Preferably, projectiles of the invention are comprised of a porous, unfinished wood, or a wood composite. Those of skill in the art will be familiar with wood composites made from wood chips or sawdust and a biodegradable adhesive.

The invention also provides a kit that comprises a sling, at least one projectile that is comprised of wood and saturated with an animal attractant, and a resealable pouch that comprises plastic and an aluminum backing and in which the projectile is kept until use. Advantageously the pouch is constructed of sufficiently thick and suitable materials such that as long as the pouch remains sealed no odor escapes from or through it. Preferred pouches are constructed of Mylar® or a plastic having similar properties with an aluminum backing.

Methods of the invention provide a means of projecting a scent from one location to another location comprising saturating a wooden ball with a scent; inserting the wooden ball into a sling that comprises an elastic band with a first end attached to a first loop and a second end attached to a second loop; positioning the first loop over a first finger and the second loop over a second finger; gripping the wooden ball and sling together and stretching the sling; and releasing the wooden ball and sling such that the wooden ball is projected to a location remote from the location of the sling.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description. Further, while specific advantages of the invention are detailed herein, various embodiments may include some, none, or all of these enumerated advantages.

### BRIEF DESCRIPTION OF THE DRAWINGS

The following drawings form part of the present specification and are included to further demonstrate certain aspects of the invention. The invention may be better understood by reference to one or more of these drawings in combination with the detailed description presented herein. Unless specifically noted, articles depicted in the drawings are not necessarily drawn to scale.

FIG. 1 shows a perspective view of a preferred sling of the invention.

FIG. 2 shows an exploded view of the sling shown in FIG. 1.

FIG. 3 shows a view of the preferred sling of the invention from above.

FIG. 4 is a frontal view of the sling shown in FIG. 1.

FIG. 5 is a view of a preferred embodiment of a scented ball.

FIG. 6 illustrates a method of using the invention.

### DETAILED DESCRIPTION

The invention provides systems and methods that include a sling and a projectile that is saturated with an attractant. Kits of the invention also include a resealable pouch.

After dozens of trial tests, the inventors found that the combination of materials and dimensions of the sling greatly influenced whether a projectile could be launched with reasonable accuracy a sufficient distance from the user to reach a desired target area. In particular, the inventors found that the material for the sling needed to have sufficient resistance or elasticity and the sling's length needed to be limited. If the slings were too long, then the projectiles would fail to launch and remain in the slings.

Slings can range from 2.5 inches to 12 inches in length and from 1 inch to 2.5 inches in width. Preferred slings range from 2.75 inches to 11 inches in length and from 1.18 inches to 1.6 inches in width. Most preferably, slings are 2.76 inches in length and 1.18 inches in width. Slings of the most preferable dimensions yielded the furthest flight with the minimum amount of elastic or flexible material. Slings are comprised of an elastic or flexible band to which two loops are attached.

The loops that attach to the elastic band are made from a strip of material that is preferably 5 inches in length and 2 inches in width. The dimensions of the strips used to make the loops can be varied, but these dimensions yield loops that are large enough to easily accommodate most users' fingers. A preferred material for the loops is leather because of its durability, ability to retain its shape, and comfort. Those of skill in the art will appreciate that another material having similar characteristics may be substituted for leather.

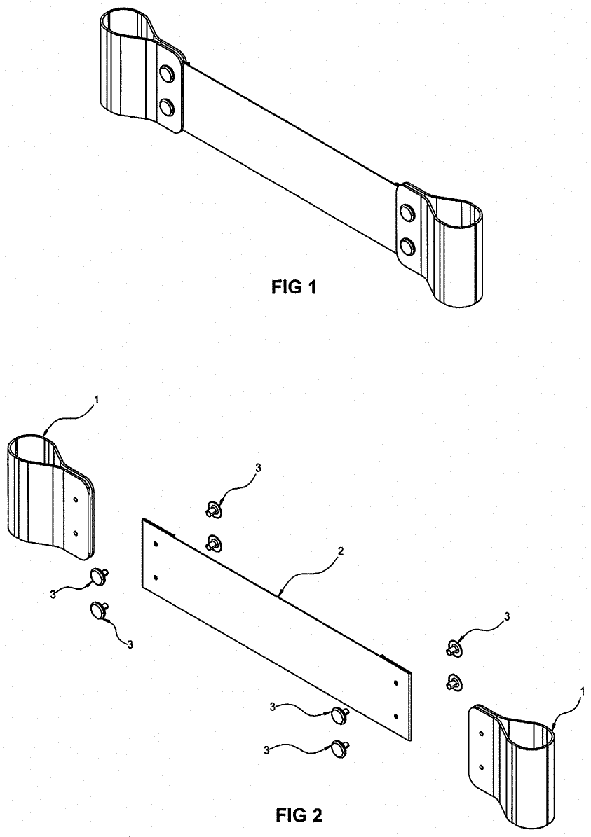

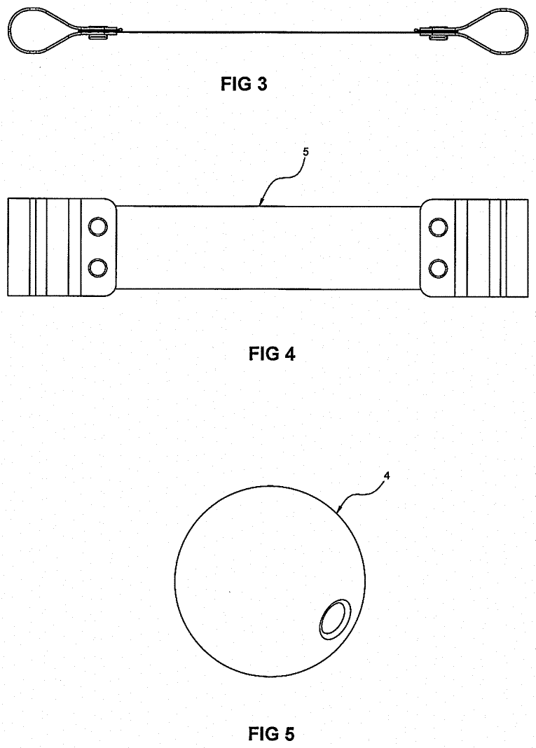

Loops may be attached to slings with a variety of suitable materials such as stitching, screws, staples, etc. that are well-known in the art. Preferably, each loop is attached to an end of the flexible band with rivets. While one rivet can be sufficient to attach a loop to an end of a flexible band, it is preferably to use two rivets that are set equidistant from the upper and lower edges of the flexible band. While there is some flexibility in the exact placement of the rivets, those of skill in the art will appreciate that there should be sufficient overlap of the loops with the flexible band such that the loops remain attached to the flexible band after repeated uses. A preferred sling is illustrated in FIGS. 1-4.

As shown in FIG. 2, a preferred sling includes an elastic band 2 having a first end and a second end. Loops 1 are attached to the ends of the elastic band 2. More specifically, a first loop 1 is attached to a first end of elastic band 2 and a second loop 1 is attached to the second end of elastic band 2. As illustrated, two rivets 3 attach the first loop 1 to a first end of elastic band 2, and similarly two rivets 3 also attach the second loop 1 to the second end of elastic band 2.

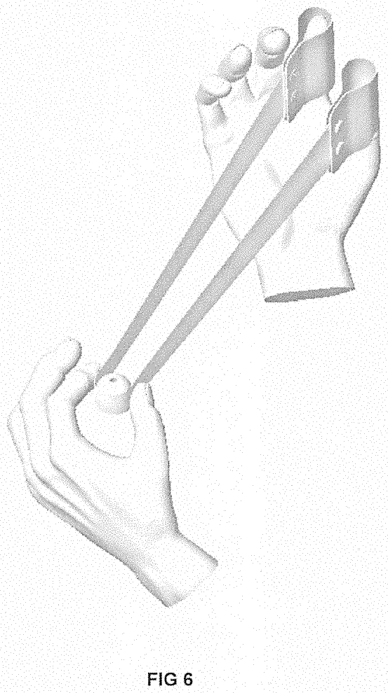

The skilled artisan will recognize that a variety of projectiles can be used in the invention. Herein, are disclosed projectiles that the inventors have found to be particularly suitable. A preferred projectile is illustrated in FIG. 5.

A preferred projectile is spherical and approximately 25 mm in diameter. Ovoid projectiles were also found to be acceptable. Preferably, a projectile is a natural, unfinished wooden ball. Alternatively, a projectile can be comprised of wood chips or sawdust and a biodegradable adhesive.

Preferred projectiles include a single hole of variable size, shape, and depth in its middle or central area. The hole does not penetrate from side to the another side of the projectile. The purpose of the hole is to increase the surface area through which an attractant can be absorbed into the projectile.

FIG. 6 illustrates a close up of a user's hands preparing to use the invention. Specifically, a user inserts fingers (e.g. a finger and a thumb) of one hand (a first hand) through the loops of the sling; places the projectile near the middle of the sling so that the projectile is cradled by the sling; and using the other hand (a second hand) pulls the cradled projectile and sling away from the loops of the sling so that the sling is stretched. A user would then aim at the desired area and release the cradled projectile so that it was propelled towards the desired area.

Kits of the invention include projectiles that have been pre-treated with an attractant so that a user does not need to apply an attractant out in the field. Projectiles are soaked for a minimum of three days in an attractant (e.g. deer urine) before being packaged in a kit. Projectiles are put into a plastic pouch or bag with approximately two ounces of the attractant with which they were treated to ensure that the attractant remains strongly absorbed to the projectiles.

Preferred kits include a resealable, clamshell pouch made of Mylar® or a similar material with an aluminum backing.

Unless defined otherwise, all technical and scientific terms used herein have the same meaning as is commonly understood by one of skill in the art to which this invention belongs at the time of filing. Terminology that is used herein is for the purpose of describing particular embodiments of the invention and is not intended to be limiting. The meaning and scope of terms should be clear; however, in the event of any latent ambiguity, definitions provided herein take precedent over any dictionary or extrinsic definition. Further, unless otherwise required by context, singular terms shall include pluralities and plural terms shall include the singular unless the content clearly dictates otherwise. Herein, the use of “or” means “and/or” unless stated otherwise. Furthermore, the use of the term “including” or “comprising”, as well as other forms such as “includes”, “included”, “comprises”, and “comprised” is not limiting. As used herein, “each” refers to each member of a set or each member of a subset of a set. All patents and publications referred to herein are incorporated by reference to the extent that they provide explanatory information.

In light of this disclosure, those of skill in the art will appreciate that many changes can be made in the specific embodiments which are disclosed and still obtain a like or similar result without departing from the spirit and scope of the invention. Thus, the present invention should not be limited to the exemplary embodiments and techniques illustrated herein.

What is claimed is:

1. A system for projecting a scent from one location to another location comprising
a) a sling that comprises a first loop, a second loop, and an elastic band that has two ends, wherein the first loop is attached to a first end of the elastic band, and the second loop is attached to a second end of the elastic band; and
b) a projectile that is comprised of wood and saturated with an animal attractant.

2. The system of claim 1, wherein the first loop is attached to the first end of the elastic band with two fasteners, and the second loop is attached to the second end of the elastic band with two fasteners.

3. The system of claim 2, wherein the fasteners are rivets.

4. The system of claim 1, wherein the first and second loops are flexible and comprised of leather.

5. The system of claim 1, wherein the projectile is a sphere or ovoid that includes a centrally located hole of variable depth.

6. The system of claim 1, wherein the projectile is comprised of a porous wood, wood chips and a biodegradable adhesive, or sawdust and a biodegradable adhesive.

7. A kit for projecting a scent from one location to another location comprising
a) a sling that comprises a first loop, a second loop, and an elastic band that has two ends, wherein the first loop is attached to a first end of the elastic band, and the second loop is attached to a second end of the elastic band; and
b) a projectile that is comprised of wood and saturated with an animal attractant; and
c) a pouch comprised of plastic and an aluminum backing, wherein the pouch is resealable.

8. The kit of claim 7, wherein the first loop is attached to the first end of the elastic band with two fasteners, and the second loop is attached to the second end of the elastic band with two fasteners.

9. The kit of claim 8, wherein the fasteners are rivets.

10. The kit of claim 7, wherein the first and second loops are flexible and comprised of leather.

11. The kit of claim 7, wherein the projectile is a sphere or ovoid that includes a centrally located hole of variable depth.

12. The kit of claim 7, wherein the projectile is comprised of a porous wood, wood chips and a biodegradable adhesive, or sawdust and a biodegradable adhesive.

13. A method for projecting a scent from one location to another location comprising
a) saturating a wooden ball with a scent;
b) inserting the wooden ball into a sling that comprises an elastic band with a first end attached to a first loop and a second end attached to a second loop;
c) positioning the first loop over a first finger and the second loop over a second finger;
d) gripping the wooden ball and sling together and stretching the sling; and
e) releasing the wooden ball and sling such that the wooden ball is projected to a location remote from the location of the sling.

14. The method of claim 13, wherein the first loop is attached to the first end of the elastic band with two fasteners, and the second loop is attached to the second end of the elastic band with two fasteners.

15. The system of claim 14, wherein the fasteners are rivets.

16. The system of claim 13, wherein the first and second loops are flexible and comprised of leather.

17. The system of claim 13, wherein the wooden ball is a sphere or ovoid that includes a centrally located hole of variable depth.

18. The system of claim 13, wherein the wooden ball is comprised of a porous wood, wood chips and a biodegradable adhesive, or sawdust and a biodegradable adhesive.
